(19) United States
(12) Patent Application Publication
(10) Pub. No.: US 2023/0382709 A1
(43) Pub. Date: Nov. 30, 2023

(54) VALVE UNIT FOR A BEVERAGE CONTAINER

(71) Applicant: Emanuela Covi, Merano (IT)

(72) Inventor: Emanuela Covi, Merano (IT)

(21) Appl. No.: 18/032,666

(22) PCT Filed: Oct. 19, 2021
(86) PCT No.: PCT/IT2021/050339

§ 371 Date: Apr. 19, 2023

(30) Foreign Application Priority Data
Oct. 20, 2020 (IT) 102020000024703

(51) Int. Cl. B67D 1/08; B67D 1/04

(52) U.S. Cl. CPC B67D 1/0835; B67D 1/0462

(57) ABSTRACT

A valve unit for a container includes a valve body and a spring device disposed inside it and provided with an upper plate. The valve body has a top wall provided with a central delivery aperture and a mating sealing lid. The sealing lid and upper plate include reciprocal coupling members.

### FIELD OF THE INVENTION

The present invention concerns a valve unit that can be used in containers for beverages, or liquids in general, and can be associated with delivery devices in order to extract them.

The containers in question are “keg” type containers or other containers known per se in which the beverage is extracted by means of a delivery device through a valve unit which has to guarantee a perfect seal even if the delivery devices are extracted from a container that is not finished, for example in order to change the beverage.

### BACKGROUND OF THE INVENTION

Valve units are known, to control and regulate a flow of beverage extracted from a container.

The valve unit is generally associated with the mouth of the container and is typically covered by a cap provided with a tamper-proof tab.

The valve unit has a valve body provided at the top with an access wall, which has a central frangible zone defining a sealing lid, and is provided at the bottom with a coupling collar to which a containing and support element is attached, in order to house a spring device.

The spring device is disposed between the access wall and a bottom wall of the containing element which can also be made integrally with the valve body, defining a single component.

The sealing lid is temporarily integral with an annular portion of the access wall and is separated from it by the thrust of the delivery device when the container is first used.

The separation of the sealing lid allows access to a delivery aperture through which the delivery device to extract the beverage passes.

The sealing lid, once separated, is then thrust to cooperate with an upper plate of the spring device so as to move integrally with it.

A similar solution is described for example in patent application WO2019/207615A2 in the name of the present Applicant.

However, sealing devices and spring devices of the known type are not always able to guarantee a correct and stable reciprocal coupling, so that under certain conditions it may happen that the two components are not perfectly and stably coupled.

A correct reciprocal coupling of the two components is necessary to prevent the sealing lid from falling inside the valve body, causing obstructions to the movement of the spring device and to allow correct re-closing of the delivery aperture.

This last aspect is of primary importance especially if one decides to change the container and the beverage inside is not finished.

In this case, if the spring device, rising due to the extraction of the delivery device, does not return the sealing lid to an almost correct position, an unwanted spillage of beverage from the container could occur.

There is therefore a need to perfect a valve unit for a container which can overcome at least one of the disadvantages of the state of the art.

In particular, one purpose of the present invention is to provide a valve unit which, when the container is first used, allows the sealing lid to be stably coupled to the upper plate of the spring device.

Another purpose of the present invention is to provide a valve unit in which the coupling is achieved in a very simple way.

Another purpose is to provide a valve unit in which the sealing lid can close the delivery aperture and prevent unwanted spillages of beverage.

The Applicant has devised, tested and embodied the present invention to overcome the shortcomings of the state of the art and to obtain these and other purposes and advantages.

### SUMMARY OF THE INVENTION

The present invention is set forth and characterized in the independent claim. The dependent claims describe other characteristics of the present invention or variants to the main inventive idea.

In accordance with the above purposes, a valve unit for a container, which overcomes the limits of the state of the art and eliminates the defects present therein, comprises a valve body which develops along a longitudinal axis and a spring device disposed coaxial inside it and provided with an upper plate.

The valve body has a top wall provided with a central delivery aperture and a mating sealing lid which, in a condition of first use of the container, is attached in a hermetically sealed manner to the top wall and is aligned with the upper plate and, in a condition of use, is stably coupled to the upper plate.

The sealing lid and the upper plate comprise reciprocal coupling members.

According to one aspect, in the condition of use as above the reciprocal coupling members are in reciprocal contact with respect to a respective surface having a coupling height comprised between about 1.8 and 3 times a thickness of the sealing lid as above.

According to another aspect, the reciprocal coupling members are made in a single body with the sealing lid and with the upper plate. The reciprocal coupling members are configured to advantageously determine a coupling of the non-reversible type, for example a snap-in coupling.

According to another aspect, the reciprocal coupling members as above comprise at least one protruding element which projects from a coupling surface of the sealing lid or from an opposite connection surface of the upper plate, and at least one mating seating made respectively in the upper plate or in the sealing lid.

According to another aspect, the at least one protruding element and the at least one mating seating have a conical or truncated-conical profile.

According to another aspect, the protruding element is configured as an annular protrusion suitable to be inserted in a seating configured as an annular hollow. The annular protrusion and the annular hollow have a radial reference measurement, measured from the longitudinal axis, which is almost the same and comprised between about 3 mm and about 10 mm.

According to another aspect, the annular hollow divides the upper plate into a peripheral portion and into a central portion from which a plurality of ribs project radially, inside the annular hollow.

According to another aspect, the connection surface has a central depression delimited by an annular shoulder in order to clamp the sealing lid in the radial direction.

According to another aspect, the reciprocal coupling members comprise a plurality of protruding elements configured as individual protrusions suitable to be inserted in respective seatings configured as individual shaped hollows.

According to another aspect, each of the protrusions comprises an end portion which defines a hook-type attachment with the mating shaped hollow, or comprises ridges or corrugations.

According to another aspect, the at least one seating is made through the thickness of the upper plate or the thickness of the sealing lid.

### BRIEF DESCRIPTION OF THE DRAWINGS

These and other aspects, characteristics and advantages of the present invention will become apparent from the following description of some embodiments, given as a non-restrictive example with reference to the attached drawings wherein:

FIG. 1 is a section view of a valve unit for a container in accordance with some embodiments described here;

FIG. 2 is an enlarged detail of FIG. 1 in which the sealing lid is in a condition of first use;

FIG. 3 is a view of the detail of FIG. 2 in which the sealing lid is in a condition of use;

FIGS. 4-5 are variants of the valve unit of FIG. 1;

FIG. 6 is a perspective view of the spring device visible in FIG. 1;

FIG. 7 is a top view of FIG. 6;

FIG. 8 is a schematic view of the coupling between the sealing lid and the upper plate of the spring device of FIG. 6;

FIGS. 9-12 are variants of the coupling between the sealing lid and the upper plate of the spring device.

To facilitate comprehension, the same reference numbers have been used, where possible, to identify identical common elements in the drawings. It is understood that elements and characteristics of one embodiment can conveniently be combined or incorporated into other embodiments without further clarifications.

### DETAILED DESCRIPTION OF SOME EMBODIMENTS

We will now refer in detail to the possible embodiments of the invention, of which one or more examples are shown in the attached drawings, by way of a non-limiting illustration. The phraseology and terminology used here is also for the purposes of providing non-limiting examples.

With reference to FIG. 1, a valve unit 10 for a container comprises a valve body 11 which develops along a longitudinal axis X.

The container can be for example of the BIC (Bag in Container) type, comprising an external keg and an internal bag, which can be obtained by blow molding preforms.

By way of example, the container can contain a beverage, such as beer, or another carbonated beverage, such as sparkling wine, or a soft drink, or even a non-carbonated beverage, such as for example wine or other, or other types of liquids, such as water, oils, detergents, or suchlike.

The valve body 11 has a coupling portion 12 conformed to receive a delivery device 100 and a containing portion 13 configured to house a spring device 14.

The containing portion 13 can be made in a single body with the coupling portion 12, FIGS. 4-5, or it can be a distinct and separate component from the coupling portion 12 and be associated with it in a known way, for example with an interlocking coupling, FIG. 1.

The coupling portion 12 comprises a top wall 15, provided with a central delivery aperture 16, and a sealing lid 17 having a shape mating with that of the delivery aperture 16.

In particular, the sealing lid 17 can be made in a single body with the top wall 15.

In an initial state, the sealing lid 17 is disposed in a closed condition, in which it is connected, that is, attached in a hermetically sealed manner to the top wall 15 in order to seal the delivery aperture 16, and during use it can assume a condition of use in which it is separated from the top wall 15 to allow access to the delivery aperture 16 and is coupled to the spring device 14.

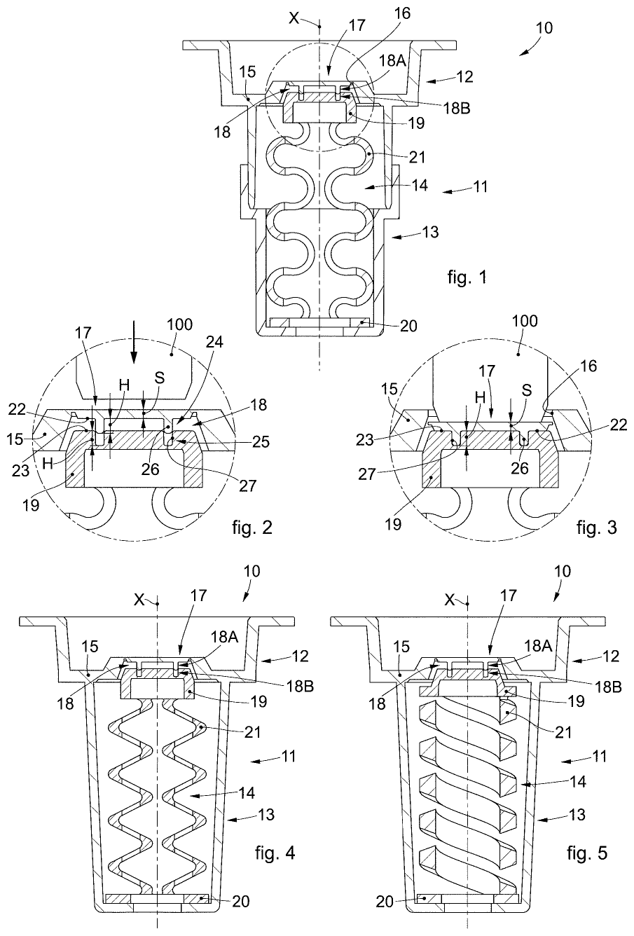

The sealing lid 17 is breakable when the valve unit 10, or the container in which it is inserted, is used for the first time and it is completely separable from the top wall 15 through the action of an external element, for example a delivery device 100, which thrusts the breakable sealing lid 17 toward the spring device 14 in the direction of the longitudinal axis X, FIGS. 2-3.

The sealing lid 17 and the spring device 14 comprise reciprocal coupling members 18 having a coupling height H measured along the longitudinal axis X suitable to make the sealing lid 17 integral with the spring device 14, determining a stable and permanent coupling.

The reciprocal coupling members 18 are configured to determine an interlocking mechanical coupling. The coupling made is preferably of the non-reversible type or at least such that the separation of the sealing lid 17 from the spring device 14 after they have been joined is substantially impossible or it can be achieved in a complicated, cumbersome and laborious way.

This coupling guarantees that the two components—sealing lid 17 and spring device 14—remain reciprocally joined for the entire duration at least of the container, thus guaranteeing an optimal closure thereof in case of removal of the delivery device 100. In this case, in fact, the no longer compressed spring device 14 extends and returns the sealing lid 17 integral with it in correspondence with the delivery aperture 16 in order to close the latter.

According to one aspect, in the condition of use as above the reciprocal coupling members 18 are in reciprocal contact with respect to a respective surface having a coupling height H comprised between about 1.8 and 3 times a thickness S of the sealing lid 17.

The ratio between the thickness S of the sealing lid 17 and the coupling height H of the reciprocal coupling members 18 is therefore comprised between about 0.3 and about 0.6.

In this way, when the delivery device 100 presses the sealing lid 17 and separates it from the top wall 15, the sealing lid 17 anchors itself in a stable and integral way to the spring device 14.

When the delivery device 100 is removed, the elastic compression force of the spring device 14 will tend to take the sealing lid 17, connected to it, to couple to the delivery aperture 16, causing an at least partial closure thereof.

In fact, the reciprocal coupling members 18 are also configured to correctly position the sealing lid 17 on the spring device 14 in such a way as to allow, in a return travel of the spring device 14, the correct closure of the delivery aperture 16.

The spring device 14 comprises an upper plate 19, a lower plate 20 and an elastic portion 21 which develops around the longitudinal axis X and is associated between them. The upper plate 19 is aligned below the sealing lid 17.

The elastic portion 21 can have the most varied shapes, for example it can have a plurality of loops, FIG. 1, or it can have a “zig-zag” configuration, FIG. 4, or again it can have a helical configuration, FIG. 5, or other known configurations or ones that will be developed in the future.

The sealing lid 17, in the condition of use, is coupled to the upper plate 19.

The sealing lid 17 and the upper plate 19 have substantially the same shape, in this specific case, a circular one.

The sealing lid 17 comprises at the lower part a coupling surface 22 facing and opposite a connection surface 23 of the upper plate 19.

The coupling surface 22 and the connection surface 23 are substantially parallel to each other and orthogonal to the longitudinal axis X.

The reciprocal coupling members 18 are made in a single body with the sealing lid 17 and with the upper plate 19 respectively. However, we do not exclude solutions in which the reciprocal coupling members 18 are made as distinct components with respect to the sealing lid 17 and to the upper plate 19 and are associated with them in a known way.

The reciprocal coupling members 18 comprise first coupling members 18A, belonging to the sealing lid 17, and second coupling members 18B, belonging to the upper plate 19. The first coupling members 18A and the second coupling members 18B can be conformed as a male element or with a mating female element or vice versa, as will be described in more detail below.

The reciprocal coupling members 18 comprise at least one protruding element 24, which projects from the coupling surface 22 or from the connection surface 23, and at least one mating seating 25, made in the upper plate 19 or in the sealing lid 17 respectively.

The at least one protruding element 24 and the corresponding seating 25 have an overall development substantially orthogonal to the respective coupling 22 or connection 23 generating surfaces.

The at least one protruding element 24 and the corresponding seating 25 have a reciprocal size at least equal to the coupling height H.

According to possible embodiments, the seating 25 can be made through in the thickness of the upper plate 19 or, in the opposite case, in the thickness S of the sealing lid 17. In this case, the protruding element 24 can be anchored to an internal surface of the upper plate 19 or to an upper surface of the sealing lid 17.

When the sealing lid 17 is in the closed condition, the at least one protruding element 24 and the corresponding seating 25 are vertically aligned and the protruding element 24 can advantageously be at least partly pre-inserted in the seating 25 by a determinate measure smaller than coupling height H.

According to some embodiments, on at least one of either the at least one protruding element 24 or the seating 25 there can be ridges 31 or ribs 34 suitable to create a reciprocal coupling by interference between the sealing lid 19 and the spring device 14.

According to some embodiments, shown in FIGS. 2-3 and FIGS. 8-10, the protruding element 24 can be configured as an annular protrusion 26 suitable to be inserted in a seating 25 configured as an annular hollow 27.

The annular protrusion 26 can be made on the sealing lid 17 and the annular hollow 27 can be made on the upper plate 19, FIGS. 2-3 and FIGS. 8-9, or the annular protrusion 26 can be made on the upper plate 19 and the annular hollow 27 can be made on the sealing lid 17, FIG. 10.

With particular reference to the example of FIG. 9, the connection surface 23 can have a central depression delimited by an annular shoulder 28 configured to clamp the sealing lid 17 in the radial direction. The central depression is able to almost completely accommodate the sealing lid 17.

The annular protrusion 26 and the annular hollow 27 have a radial reference measurement, measured from the longitudinal axis X, which is almost the same and comprised between about 3 mm and about 10 mm.

The annular protrusion 26 and the annular hollow 27 can have respective inclined surfaces to promote the reciprocal coupling. For example, the annular protrusion 26 and the annular hollow 27 can have a taper with an opening angle α comprised between about 10° and about 30°, preferably around 20°, see for example FIG. 8.

According to possible embodiments, the sealing lid 17 can have a smooth upper surface or it can have hollows, or reliefs, ribs or depressions.

According to other embodiments, shown in FIGS. 11-12, the reciprocal coupling members 18 can comprise a plurality of protruding elements 24 configured as individual protrusions 29 suitable to be inserted in respective seatings 25 configured as individual shaped hollows 30.

The protrusions 29 can be equidistant on the coupling surface 22 and they can be disposed, for example, along a circumference or on the entire coupling surface 22.

In the example shown in FIGS. 11-12, there are four protrusions 29 equidistant at 90°.

Each protrusion 29 can comprise an end portion, which defines a hook-type attachment with the mating shaped hollow 30, FIG. 10, or it can comprise ridges or corrugations 31 to allow a more stable reciprocal positioning.

The presence of the hook-type attachment 29 and of the corrugations 31 can also be contemplated in the case of an annular protrusion 26, as in the type shown in FIGS. 8-9.

Each protrusion 29 and each mating shaped hollow 30 can have a cylindrical shape or a conical or truncated-conical shape with a cross section that decreases as it moves away from the coupling surface 22 and from the connection surface 23 respectively, and having an opening angle α comprised between about 10° and about 30°.

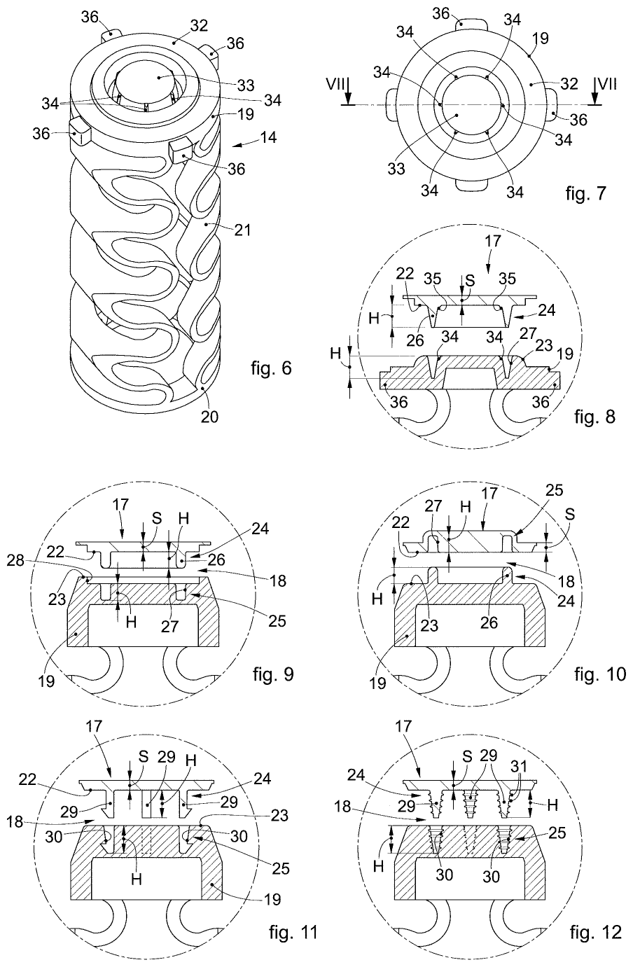

According to some embodiments, described with reference to the spring device 14 of FIGS. 6-7, the annular hollow 27 divides the upper plate 19 into a peripheral portion 32 and into a central portion 33 from which a plurality of ribs 34 project radially, inside the annular hollow 27.

In this case, the sealing lid 17, not shown, has corresponding slits 35 or hollows in which the ribs 34 can slide and be inserted. This embodiment can also be provided with the ribs 34 made on the sealing lid 17 and the slits made on the upper plate 19.

According to some embodiments, the sealing lid 17 is protruding with respect to an upper surface of the top wall 15, and is hollowed with respect to an opposite lower surface.

The thickness S of the sealing lid 17 is smaller than the thickness of the top wall 15. This thickness is particularly reduced in correspondence with the edge of connection with the perimeter walls of the delivery aperture 16, in order to facilitate the separation during the step of first use of the container.

By way of example, the zone of connection/separation between the top wall 15 and the sealing lid 17 can be comprised between 0.1 and 0.5 times the thickness S of the sealing lid 17.

Furthermore, as shown in the example of FIG. 10, the sealing lid 17 can also have zones with a thickness greater than the thickness S.

According to other embodiments, shown by way of example in FIGS. 6-8, the spring device 14 can comprise positioning means 36 which extend radially beyond an external perimeter of the upper plate 19, having the function of cooperating with the valve body 11 in order to keep the spring device 14 aligned along the longitudinal axis X.

According to some embodiments, the positioning means comprise a plurality of fins 36 disposed distanced along the circumference.

It is clear that modifications and/or additions of parts may be made to the valve unit 10 as described heretofore, without departing from the field and scope of the present invention as defined by the claims.

In the following claims, the sole purpose of the references in brackets is to facilitate reading: they must not be considered as restrictive factors with regard to the field of protection claimed in the specific claims.

1. A valve unit for a container comprising a valve body which develops along a longitudinal axis and a spring device disposed coaxial inside it and provided with an upper plate, said valve body having a top wall provided with a central delivery aperture and a mating sealing lid which in a condition of first use is connected in a hermetically sealed manner to said top wall and is aligned with said upper plate, and in a condition of use it is stably coupled to said upper plate, said sealing lid and upper plate comprising reciprocal coupling members, wherein in said condition of use said reciprocal coupling members are in reciprocal contact and interfering with respect to a respective surface having a coupling height comprised between about 1.8 and 3 times a thickness of said sealing lid.

2. The valve unit as in claim 1, wherein said reciprocal coupling members are made in a single body with said sealing lid and with said upper plate respectively, wherein said reciprocal coupling members are configured to determine a coupling of the non-reversible type.

3. The valve unit as in claim 1, wherein said reciprocal coupling members comprise at least one protruding element which projects from a coupling surface of said sealing lid or from an opposite connection surface of said upper plate, and at least one mating seating made respectively in the upper plate or in the sealing lid.

4. The valve unit as in claim 3, wherein on at least one of either said protruding element or said seating there are ridges or ribs suitable to create a coupling by interference.

5. The valve unit as in claim 3, wherein said at least one protruding element and said at least one mating seating have a conical or truncated-conical profile characterized by an opening angle comprised between about 10° and about 30°.

6. The valve unit as in claim 3, wherein said seating is configured as an annular hollow and said protruding element is configured as an annular protrusion suitable to be inserted in said seating.

7. The valve unit as in claim 4, wherein said annular hollow divides said upper plate into a peripheral portion and into a central portion from which said ribs project radially, inside said annular hollow.

8. The valve unit as in claim 7, wherein said sealing lid has slits or hollows in which said ribs are inserted.

9. The valve unit as in claim 5, wherein said annular protrusion and said annular hollow have a radial reference measurement, measured from said longitudinal axis, which is almost the same and comprised between about 3 mm and about 10 mm.

10. The valve unit as in claim 3, wherein said connection surface has a central depression delimited by an annular shoulder in order to clamp said sealing lid in the radial direction.

11. The valve unit as in claim 1, wherein said reciprocal coupling members comprise a plurality of protruding elements configured as individual protrusions suitable to be inserted in respective seatings configured as individual shaped hollows.

12. The valve unit as in claim 11, wherein each protrusion comprises an end portion that defines a hook-type attachment with the mating shaped hollow, or comprises ridges or corrugations.

13. The valve unit as in claim 1, wherein said at least one seating is made through in the thickness of said upper plate or in the thickness of said sealing lid.

14. A container comprising an external keg, an internal bag and a valve unit as in claim from 1.
